(19) United States
(12) Patent Application Publication
(10) Pub. No.: US 2009/0143888 A1
(43) Pub. Date: Jun. 4, 2009

(54) METHOD AND SYSTEM FOR PRODUCT PROJECTION ANALYSIS

(76) Inventors: Eduard Korat, Campbell, CA (US); Ganesh Vellore, San Francisco, CA (US)

Correspondence Address: SAP AG, 3410 HILLVIEW AVENUE, PALO ALTO, CA, 94304, US

(21) Appl. No.: 11/947,805

(22) Filed: Nov. 30, 2007

(51) Int. Cl. G06F 19/00

(52) U.S. Cl. 700/102

(57) ABSTRACT

Disclosed is a method and system for generating a projection result of a product quantity. The generation of the projection result involves generating a product group for the product quantity by extracting a first partial product group from an actual output and extracting a second partial product group from an actual input, generating the projected result for the product quantity by moving the product group from a first production phase to a second production phase and outputting the projected result for the product quantity.

### FIELD OF THE INVENTION

The invention generally relates to the field of a supply chain management and more specifically relates to the field of a projection result of a product quantity.

### BACKGROUND OF THE INVENTION

In a product manufacturing process, product orders given by a customer to a supplier have to be processed typically within a specified period of time. To manufacture a product, certain manufacturing resources have to be considered. The manufacturing resource typically includes raw materials, machine, production time and working hours. To efficiently use the manufacturing resources a manufacturer may employ systems and methods for scheduling the use of different resources at different dates and times to keep the manufacturing process at peak efficiency. In a product delivery process, the delivery of the products to the customer at the specified period of time plays a vital role. Tracking the delivery process of the products may include projecting a quantity of the product that needs to be delivered to the customer within a specified period of time. Typically projecting a quantity of the product involves the process of tracking the product quantity at an end of a final production phase. The existing methods and systems typically do not meet the need for tracking the product quantity at each production phase and projecting the product quantity that needs to be delivered to the customer.

### SUMMARY OF THE INVENTION

Disclosed is a method and system for generating a projection result of a product quantity. The generation of the projection result involves generating a product group for the product quantity by extracting a first partial product group from an actual output and extracting a second partial product group from an actual input, generating the projected result for the product quantity by moving the product group from a first production phase to a second production phase and outputting the projected result for the product quantity.

### BRIEF DESCRIPTION OF THE DRAWINGS

A better understanding of embodiments of the invention are illustrated by examples and not by way of limitation, the embodiments can be obtained from the following detailed description in conjunction with the following drawings, in which:

FIG. 1 is a flow diagram for generating a projected result of a product quantity according to an embodiment of the invention.

FIG. 2 is a flow diagram for generating a product group according to an embodiment of the invention.

FIG. 3 is an exemplary block diagram for generating a product group according to an embodiment of the invention.

FIG. 4 is an exemplary block diagram for moving a product group in a first production phase according to an embodiment of the invention.

FIG. 5 is an exemplary block diagram of a projection result derived from moving the product group from a first production phase to a second production phase according to an embodiment of the invention.

FIG. 6 illustrates a block diagram for generating a projected result of a product quantity according to an embodiment of the invention.

### DETAILED DESCRIPTION

Disclosed is a method and system for generating a projection result of a product quantity. The generation of the projection result involves generating a product group for the product quantity by extracting a first partial product group from an actual output and extracting a second partial product group from an actual input, generating the projected result for the product quantity by moving the product group from a first production phase to a second production phase and outputting the projected result for the product quantity.

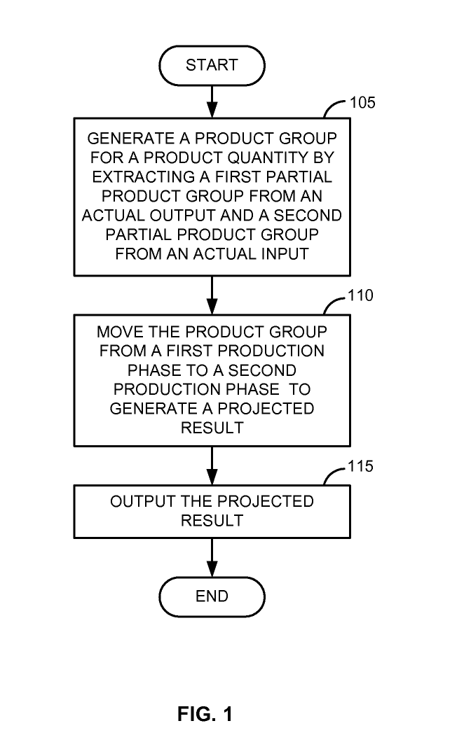

FIG. 1 is a flow diagram for generating a projected result of a product quantity according to an embodiment of the invention. At process block 105, a product group for a product quantity is generated by extracting a first partial product group from an actual output and extracting a second partial product group from an actual input. The actual input and the actual output is the product quantity that a supplier provides to a customer at a given point in time. Further, the product group is moved from a first production phase to a second production phase for generating a projected result at process block 110. The generation of the projected result involves applying a planned product quantity ratio as decided by the supplier and the customer. The planned product quantity ratio is the ratio of the planned input product quantities as decided by the supplier and the customer. In an embodiment the planned product quantity ratio is the ratio of the planned input product quantity A and planned input product quantity B. The planned output product quantity may also be in the same ratio as the planned input product quantity. A third production phase is scheduled for the product group through which the product group is moved after moving the product group from the first production phase to the second production phase. The third production phase is scheduled based on an instance of time of the product group and the duration of the third production phase. The projected result for the product quantity is outputted at process block 115. In an embodiment the product quantity at an instance of time is generated at an output device.

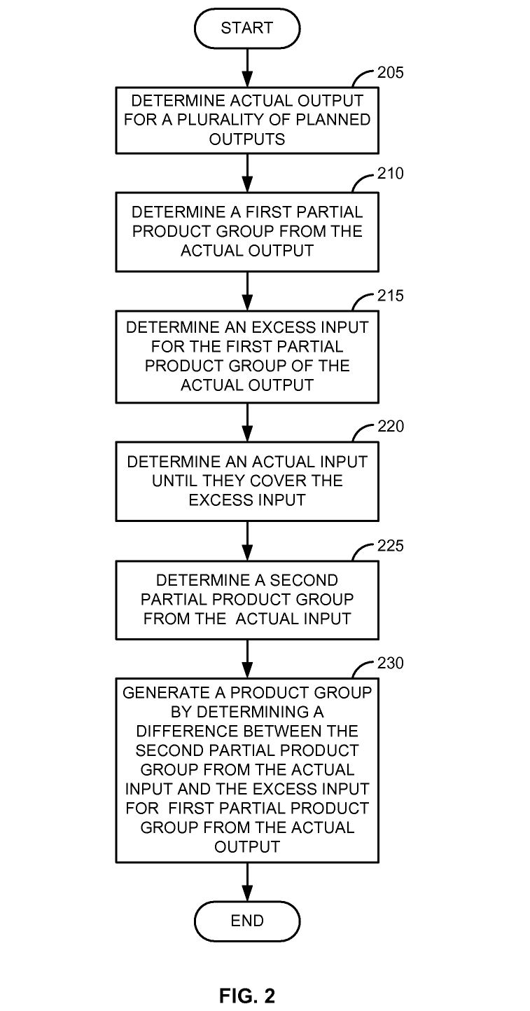

FIG. 2 is a flow diagram for generating a product group according to an embodiment of the invention. At process block 205 actual output is determined for a plurality of planned outputs. A planned input and the planned output is the product quantity that a customer and a supplier agree. An actual input and the actual output may be different from the planned input and the planned output as during the execution the capacity situation at the supplier end determines the product quantity of the supplier. A first partial product group from the actual out put is determined by applying the planned product quantity ratio at process block 210. A partial product group is a remaining part of the actual output and the actual input after applying the planned product quantity ratio. The planned product quantity ratio is decided by the supplier and the customer. An excess input is determined for the first partial product group from the actual output by applying the planned product quantity ratio at process block 215. The actual input is determined until the actual input covers the excess input of the first partial product group at the process block 220. A second partial product group from the actual input is determined at process block 225. The product group is generated by determining a difference between the second partial product group from the actual input and the excess input for first partial product group from the actual output at process block 230, that is, excess input minus actual output. In an embodiment actual input and the actual output are sorted by instance of time. In another embodiment the actual output is processed until the actual output ceases. The product group is generated by collecting a group of the actual output based on the first partial product group from the actual output. In another embodiment the actual input is processed until the actual input ceases. The product group is generated by collecting a group of the actual input based on the second partial product group from the actual input.

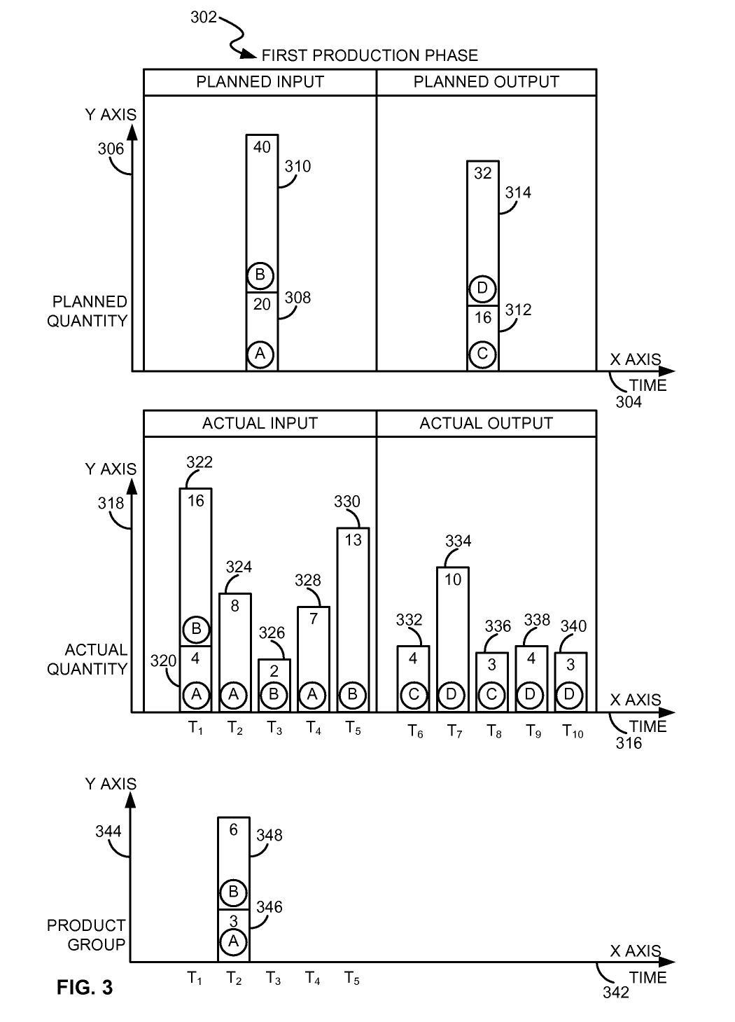

FIG. 3 is an exemplary block diagram for generating a product group according to an embodiment of the invention. Consider a business scenario where X axis 304 defines instance of time and Y axis 306 defines a planned quantity where A, B, C and D are products. A planned input 308 with product quantity 20A and the planned input 310 with product quantity 40B enter a first production phase 302 at a time instance. Product quantity 20A means a quantity of 20 units for product A. The planned output 312 with product quantity 16C and the planned output 314 with product quantity 32D are planned to exit the first production phase 302 at an instance of time. The planned input and the planned output is the product quantity that the customer and the supplier agree. The planned product quantity ratio provide the information of the expected product quantity to exit the first production phase 302 based on the product quantity that entered the first production phase 302. In the business scenario the planned product quantity ratio is 1:2. The planned product quantity ratio is determined by taking the ratio of the planned input 308 with product quantity 20A and the planned input 310 with product quantity 40B which results in ratio 1:2.

In the business scenario, X axis 316 defines instance of time and Y axis 318 defines an actual quantity. The actual input entering the first production phase 302 includes actual input 320 with product quantity 4A and actual input 322 with product quantity 16 B at a instance of time T₁, actual input 324 with product quantity 8A at a instance of time T₂, actual input 326 with product quantity 2B at a instance of time T₃, actual input 328 with product quantity 7A at a instance of time T₄ and actual input 330 with product quantity 13B at a instance of time T₅. The actual output exiting the first production phase 302 includes actual output 332 with product quantity 4C at a instance of time T₆, actual output 334 with product quantity 10D at a instance of time T₇, actual output 336 with product quantity 3C at a instance of time T₈, actual output 338 with product quantity 4D at a instance of time T₉ and actual output 340 with product quantity 3D at a instance of time T₁₀. The actual input and the actual output may be different from the planned input and the planned output as during a manufacturing process at the supplier end determines the product quantity of the supplier.

In business scenario the actual output 332 with product quantity 4C and the actual output 334 with product quantity 10D are collected for a plurality of planned outputs. A first partial product group from the actual output 332 and actual output 334 is extracted. The first partial product group for actual output 332 and actual output D 334 is determined by applying the planned product quantity ratio 1:2, resulting in the first partial product group with product quantity 4C and actual output with product quantity 8D. The first partial product group with product quantity 4C and product quantity 8D can be moved in the first production phase 302. A product quantity of 2D is remaining since the first partial product group with product quantity 8D when subtracted from actual output 334 with product quantity 10D results in 2D. An excess input corresponding to the first partial product group with product quantity 4C and 8D is determined for the first partial product group by applying the planned product quantity ratio resulting in the excess input with product quantity 5A and 10B. The actual input is collected until they cover the excess input with product quantity 5A and 10B. Three actual inputs include actual input 320 with product quantity 4A, actual input 322 with product quantity 16B and actual input 324 with product quantity 8A are collected. Actual input 320, actual input 322 and actual input 324 adds to a total of product quantity 12A and 16B covering the excess input with product quantity 5A and 10B. The second partial product group from the actual input with product quantity 12A and 16 B is determined by applying the planned product quantity ratio 1:2. The partial product group of the actual input is 8A and 16B. A product quantity of 4B is leftover, the product quantity is determined in a similar way as that of leftover product quantity 2D.

A difference between the second partial product group from the actual input with product quantity 8A, 16B and the excess input for first partial product group from the actual output with product quantity 5A, 10B and is determined, which results in a product group 346 with product quantity 3A and product group 348 with product quantity 6B referred as a first product group. The first product group is represented in an X-Y axis where X axis 342 defines instance of time and Y axis 344 defines product group. The time instance T₂ of the last included actual input 324 with product quantity 8A is added to the first product group. The position of the first product group can be described as product quantity 3A and 6B in the first production phase 302 at time instance T₂.

When extracting the first partial product group of the actual output with product quantity 4C, 8D and actual input with product quantity 8A, 16B leftover product quantity 4B occurs on the actual input and leftover product quantity 2D occurs on the actual output in the first product group. The leftover product quantity 4B is added to the actual input and the leftover product quantity 2D is added to the actual output respectively. Starting with the earliest of the remaining actual output 2D next set of actual output is collected covering the planned output. The iterations followed to determine the first product group is repeated to determine a second product group. The iterations result in a third partial product group of the actual input with the product quantity 3A and 6B and a fourth partial product group of the actual output with the product quantity 1.25A and 2.5B. The difference between the third partial product group of the actual input with product quantity 3A and 6B and the excess input for second partial product group of the actual output with product quantity 1.25A and 2.5B is determined which results in product quantity 1.75A and 3.5B. The product quantity 1.75A and 3.5B is the second separated group. The time instance T₄ of the last included actual input 326 with product quantity 7A is added to the product group. The position of the second product group can be described as 1.75A, 3.5B in the first production phase 302 at time instance T₄.

When extracting the partial product group of the actual input and actual output for the second product group leftover product quantity 4A occurs at actual input and leftover product quantity 2C occurs at the actual output in the second product group. The leftover product quantity 4A and 2C are now added to the actual input and actual output respectively. Starting with the earliest of the actual output 2C the next actual output is collected which cover the planned output. The iterations followed to determine the first product group is repeated to determine a second product group. The iterations result in the fifth partial product group of the actual input with the product quantity 4A and 8B and the sixth partial product group of the actual output with the product quantity 4A and 8B. The difference between the fifth partial product group of the actual input with product quantity 4A and 8B and the excess input for the fourth partial product group from the actual output with product quantity 4A and 8B is determined which results in product quantity 0 A and 0 B. Since, the inputs cancel each other there is no product group. This corresponds to a complete throughput of the product quantity that entered and exited within the first production phase 302. The overall extraction result in the first production phase 302 are the two product groups with product quantity 3A, 6B in the at time instance T₂ and product quantity 1.75A, 3.5B at time instance T₄.

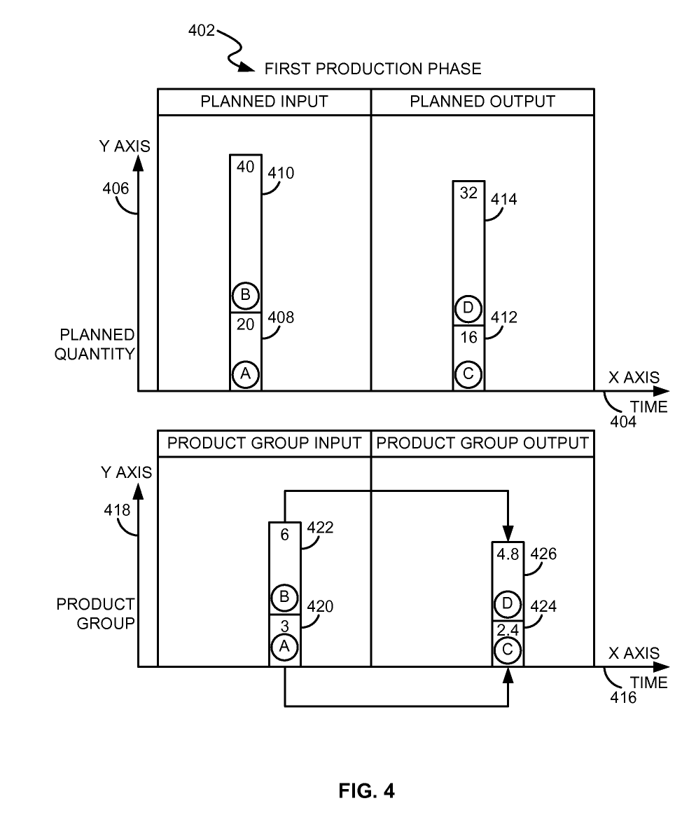

FIG. 4 is an exemplary block diagram of moving a product group in a first production phase according to an embodiment of the invention. Consider a business scenario where X axis 404 defines instance of time and Y axis 406 defines planned quantity. Planned input 408 with product quantity 20A and the planned input 410 with product quantity 40B enter a first production phase 402 at a time instance. Planned output 412 with product quantity 16C and the planned output 414 with product quantity 32D exit the first production phase 402 at a time instance. In business scenario, the first product group determined in FIG. 3 with product quantity 3A and 6B is moved in the first production phase 402. A product group 420 with product quantity 3A and product group 422 with product quantity 6B referred is represented in an X-Y axis where X axis 416 defines instance of time and Y axis 418 defines product group. The product group input 420 with product quantity 3A and product group 422 with product quantity 6B is a product group input. The planned product quantity ratio is applied to the product group 420 with product quantity 3A and product group 422 with product quantity 6B. The product group output 424 with product quantity 2.4C and product group output 426 with product quantity 4.8D is determined by multiplying the partial product group derived in FIG. 3 with product quantity 4C, 8D of the actual output by ⅗ since the product group is ⅗th of the excess input 5A, 10B. The product group output for multiple product groups is also determined in a similar way. A phase is scheduled based on the time instance of the product group taken as start time and the duration. The product group, output time and position of 2.4C, 4.8D define the projected result of the product group 420 with product quantity 3A and product group 422 with product quantity 6B.

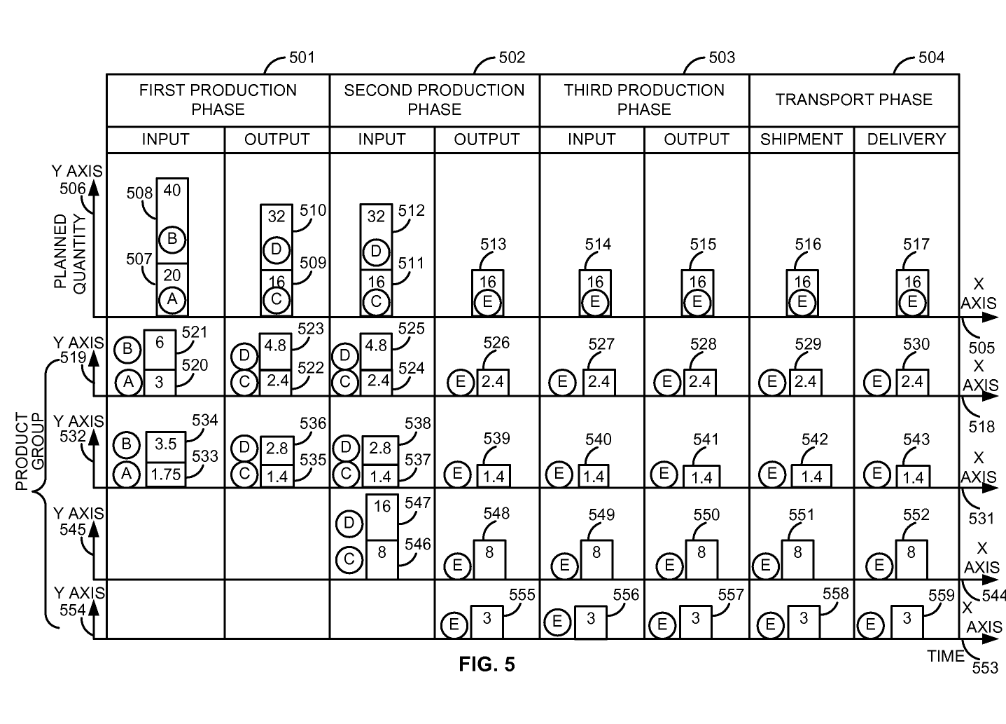

FIG. 5 is an exemplary block diagram of a projection result derived from moving the product group from a first production phase to a second production phase according to an embodiment of the invention. In business scenario, there are three production phases namely first production phase 501, second production phase 502, third production phase 503 and a transport phase 504. The transport phase 504 further includes shipment and delivery. A planned quantity is represented in an X-Y axis where X axis 505 defines instance of time and Y axis 506 defines the planned quantity. A planned input 507 with product quantity 20A and the planned input 508 with product quantity 40B enter the first production phase 501 at a time instance. Planned output 509 with product quantity 16C and the planned output 510 with product quantity 32D exit the first production phase 501 at an instance of time. The planned output 509, planned output 510 of the first production phase 501 with product quantity 16C, 32D respectively is planned input 511, planned input 512 with product quantity 16C, 32D respectively of the second production phase 502. Planned output 513 with product quantity 16E is the planned output of the second production phase 502. The planned output 513 of the second production phase 502 is planned input 514 of the third production phase 503 is product quantity 16 E and planned output 515 of third production phase 503 is product quantity 16E. The planned output 515 of the third production phase 503 is planned input 516 of the transport phase 504. The planned input 516 is shipped by the supplier. Planned output 517 of the transport phase 504 with product quantity 16E is delivered to the customer.

In business scenario there are four product groups 3A, 6B and 1.75A, 3.5B in first production phase 501, product group 8C, 16D in second production phase 502 and product group 3E in break of the second production phase 502.

The product groups are moved from the first production phase 501 to the second production phase 502, from the second production phase 502 to the third production phase 503 and from the third production phase 503 to the transport phase 504 at an instance of time. Consider product group 520, product group 521 with product quantity 3A and 6B respectively. The product group 520, the product group 521 with product quantity 3A and 6B respectively is represented in an X-Y axis where X axis 518 defines instance time and Y axis 519 defines product group. The first production phase 501 input is the product group 520, product group 521 with product quantity 3A and 6B respectively. The first production phase 501 outputs are output 522, output 523 with product quantity 2.4C, 4.8D respectively. Output 522, output 523 of the first production phase 501 is moved as input 524, input 525 to the second production phase 502. Output 526 with product quantity 2.4E is the output of the second production phase 502. Output 526 of the second production phase output with product quantity 2.4E is moved to the third production phase 503 as an input 527. Output 528 of the third production phase output 503 is moved to the transport phase 504 as input 529, the input 529 with product quantity 2.4E is shipped by the supplier. Output 530 of the transport phase 504 with product quantity 2.4 E is delivered to the customer. Product quantity 2.4E is the projected result of the product group 520, product group 521 with product quantity 3A and 6B respectively.

Consider product group 533 with product quantity 1.75A, product group 534 with product quantity 3.5B represented in an X-Y axis where X axis 531 defines instance of time and Y axis 532 defines product group. The first production phase 501 input is the product group 533 with product quantity 1.75A, the product group 534 with product quantity 3.5B. Output of the first production phase 501 is output 535, output 536 with product quantity 1.4C, 2.8D respectively. The output 535, the output 536 of the first production phase 501 is moved to the second production phase 502 as an input 537, input 538 to the second production phase 502. Output 539 exits the second production phase 502 with product quantity 1.4E. The output 539 of the second production phase 502 is moved to the third production phase 503 as an input 540 to the third production phase 503. Output 541 exits the third production phase 503 with product quantity 1.4E. The output 541 of the third production phase 503 is moved to the transport phase 504 as an input 542 to the transport phase 504. The input 542 with product quantity 1.4E is shipped by the supplier. Output 543 of the transport phase 504 with product quantity 1.4E is delivered to the customer. The product quantity 1.4E is the projected result of the product group 533 with product quantity 1.75A, product group 534 with product quantity 3.5B.

Consider a product group 546 with product quantity 8C, product group 547 with product quantity 16C represented in an X-Y axis where X axis 544 defines instance of time and Y axis 545 defines product group. The second production phase 502 input is product group 546 with product quantity 8C, product group 547 with product quantity 16C. Output 548 with product quantity 8E is the output of the second production phase 502. The second production phase output 548 is moved to the third production phase 503 as an input 549 to the third production phase. Output 550 with product quantity 8E is output of the third production phase 503. The output 550 of the third production phase 503 is moved to the transport phase 504 as an input 551. In the transport phase 504 the input 551 with product quantity 8 E is shipped by the supplier. Output 552 with product quantity 8 E of the transport phase 504 is delivered to the customer. The product quantity 8E is the projected result of the product group 546 with product quantity 8C, product group 547 with product quantity 16C.

Consider a product group 555 with product quantity 3E in the second production phase output represented in X-Y axis where X axis 553 defines instance of time and Y axis 554 defines product group. Input 556 is the third production phase 503 input with product quantity 3E. The third production phase output is output 557 with product quantity 3E. The output 557 of the third production phase 503 with product quantity 3E is moved to the transport phase 504 as an input 558 to the transport phase 504. In the transport phase 504 product quantity 3 E is shipped by the supplier and output 559 with product quantity 3 E is delivered to the customer. The product quantity 1.4E is the projected result of the product group 555 with product quantity 3E.

In the business scenario 500 the projected result is 2.4 E, 1.4 E, 8 E and 3E.

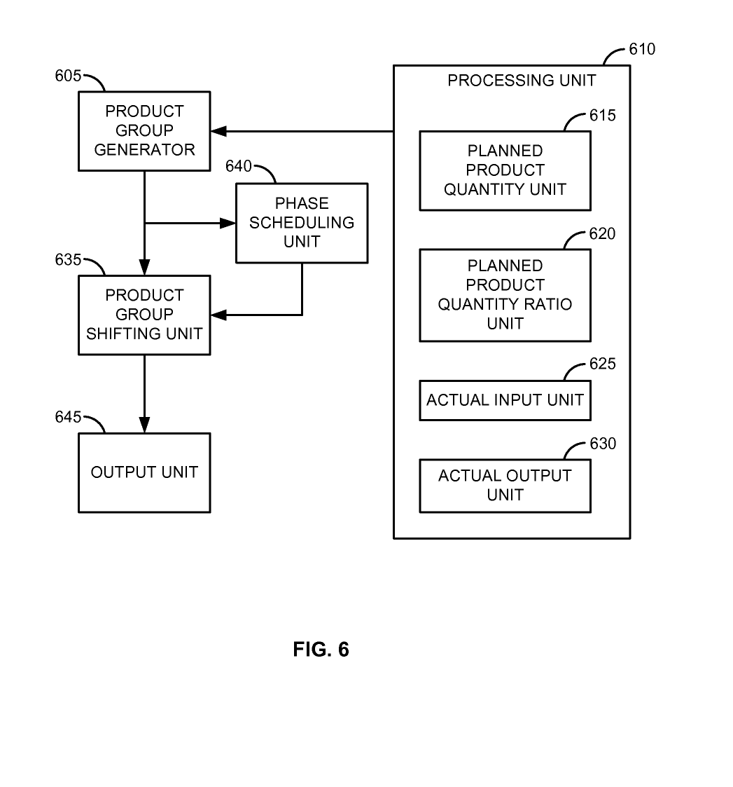

FIG. 6 illustrates a block diagram for generating a projected result of a product quantity according to an embodiment of the invention. A processing unit 610 is connected to a product group generator 605 to generate a product group for a product quantity. The processing unit 610 further includes a planned product quantity unit 615, a planned product quantity ratio unit 620, an actual input unit 625 and an actual output unit 630. The processing unit 610 is connected to the actual input unit 625 and the actual output unit 630. The planned product quantity unit 615 stores a planned input output as agreed by a supplier and a customer. The processing unit 610 processes the actual output stored in the actual output unit 630 to generate a first partial product group from the actual output. The processing unit 610 processes the actual input stored in the actual input unit 625 to generate a second partial product group from the actual input. A difference between the second partial product group from the actual input and an excess input for the first partial from the actual output is determined to result in a product group. A product group shifting unit 635 is connected to the product group generator 605 for moving the product group from a first production phase to a second production phase for generating a projected result. An output unit 645 is connected to the product group shifting unit 635 for outputting the projected result. A phase scheduling unit 640 is connected to the output of the product group generator 605. The phase scheduling unit 640 schedules a phase through which the product group is moved from a first production phase to a second production phase. The phase is scheduled based on time instance of the product group and the duration of the phase to determine the projected result for the product group.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

What is claimed is:

1. A method comprising:
generating a product group for a product quantity by extracting a first partial product group from an actual output and extracting a second partial product group from an actual input;
generating a projected result for the product quantity by moving the product group from a first production phase to a second production phase; and
outputting the projected result for the product quantity.

2. The method of claim 1, wherein generating a product group for a product quantity comprises determining an excess input corresponding to the first partial product group from the actual output.

3. The method of claim 1, wherein generating a product group for a product quantity comprises determining an excess input corresponding to the second partial product group from the actual input.

4. The method of claim 1, wherein generating a projected result further comprises applying a planned product quantity ratio to the product group.

5. The method of claim 1, wherein generating a projected result further comprises scheduling a third production phase through which the product group moves based on a time instance of the product group.

6. The method of claim 1, wherein generating the projected result of the product quantity comprises determining a difference between the second partial product group from the actual input and an excess input from the first partial product group from the actual output.

7. The method of claim 1, further comprising entering the actual input into the first production phase at a time instance.

8. The method of claim 1, wherein generating a product group for a product quantity comprises:
processing the actual input until the actual input ceases; and
generating the product group by collecting a group of the actual input based on the second partial product group from the actual input.

9. The method of claim 1, wherein generating a product group for a product quantity comprises:
processing the actual output until the actual output ceases; and
generating the product group by collecting a group of the actual output based on the first partial product group from the actual output.

10. A system, comprising:
a product group generator electronically coupled to a processing unit for generating a product group for a product quantity by extracting a first partial product group from an actual output and extracting a second partial product group from an actual input;
a product group shifting unit electronically coupled to the product group generator for moving the product group from a first production phase to a second production phase for generating a projected result; and
an output unit electronically coupled to the product group shifting unit for outputting the projected result.

11. The system of claim 10, wherein the processing unit further comprises a planned product quantity unit for storing a planned input output.

12. The system of claim 10, wherein the processing unit further comprises a planned product quantity ratio unit for storing a planned product quantity ratio.

13. The system of claim 10, wherein the processing unit further comprises an actual input unit for storing the actual input.

14. The system of claim 10, wherein the processing unit further comprises an actual output unit for storing the actual output.

15. The system of claim 10, further comprising a phase scheduling unit electronically coupled to the product group generator and the product group shifting unit for scheduling a third production phase through which the product group moves after moving from the first production phase to the second production phase.

16. A machine-accessible medium that provides instructions which, when executed by a machine, cause the machine to perform operations comprising:
generating a product group for a product quantity by extracting a first partial product group from an actual output and extracting a second partial product group from an actual input;
generating a projected result for the product quantity by moving the product group from a first production phase to a second production phase; and
outputting the projected result for the product quantity.
